(19) United States
(12) Patent Application Publication
(10) Pub. No.: US 2021/0281570 A1
(43) Pub. Date: Sep. 9, 2021

(54) ENABLING ACCESS TO DEVICES IN A COMMUNICATION NETWORK

(71) Applicant: Nokia Technologies Oy, Espoo (FI)

(72) Inventors: Dimitrios SCHOINIANAKIS, Munich (DE); Matteo SIGNORINI, Palaiseau (FR)

(21) Appl. No.: 17/259,275

(22) PCT Filed: Aug. 31, 2018
(86) PCT No.: PCT/EP2018/073449

§ 371 Date: Jan. 11, 2021

(30) Foreign Application Priority Data
Jul. 12, 2018 (GR) 20180100320

(51) Int. Cl. H04L 29/06; H04L 9/08; H04L 9/32

(52) U.S. Cl. CPC H04L 63/10; H04L 9/085; H04L 9/3239; H04L 2209/38; H04L 9/0894; H04L 9/3226; H04L 63/306; H04L 63/0442

(57) ABSTRACT

According to an example aspect of the present invention, there is provided a method comprising, generating a first and a second share of a private key associated with a terminal, generating a moduli-set associated with the terminal, transmitting the first share to a second network element and the second share to a third network element, receiving, from the second network element, a message comprising an indication that an investigation has started related to the terminal and transmitting the moduli-set associated with the terminal to the second network element.

### FIELD

Embodiments of the present invention relate in general to communication networks and enabling access to devices in such networks.

### BACKGROUND

There has been a long-lasting debate between device manufacturers, law-enforcement agencies and justice departments about the availability to decrypt and access personal devices of users, such as mobile phones, tablets, etc. In some situations it may be a problem if the manufacturer of a device cannot decrypt a personal device of a user. For example, some manufacturers may claim that their current operating systems cannot be accessed by the manufacturer due to the used security architecture, i.e., the used secure enclave architecture allows no visibility, or access, to personal devices of users. Nevertheless, for example in case of terrorists or other criminals it may be beneficial to be able to decrypt and access personal devices of some users.

Thus there is a need for providing methods, apparatuses and computer programs which allow accessing the personal devices of the users by, for example, law-enforcement agencies and justice departments, if needed. At the same time there is a need to avoid misuse of personal devices, and the information therein.

### SUMMARY OF THE INVENTION

According to some aspects, there is provided the subject-matter of the independent claims. Some embodiments are defined in the dependent claims.

According to a first aspect of the present invention, there is provided an apparatus comprising at least one processing core, at least one memory including computer program code, the at least one memory and the computer program code being configured to, with the at least one processing core, cause the apparatus at least to generate a first and a second share of a private key associated with a terminal, generate a moduli-set associated with the terminal, transmit the first share to a second network element and the second share to a third network element, receive via a blockchain, from the second network element, a message comprising an indication that an investigation has started related to the terminal and transmit the moduli-set associated with the terminal to the second network element.

According to a second aspect of the present invention, there is provided an apparatus comprising at least one processing core, at least one memory including computer program code, the at least one memory and the computer program code being configured to, with the at least one processing core, cause the apparatus at least to receive, from a first network element, a first share of a private key associated with a terminal, transmit a message, comprising an indication that an investigation has started related to the terminal, to a blockchain, receive, from a third network element, a second share of the private key associated with the terminal, receive, from the first network element, a moduli-set associated with the terminal, reconstruct the private key using the first and the second share of the private key and decrypt a password associated with the terminal using the private key and the moduli-set.

According to a third aspect of the present invention, there is provided an apparatus comprising at least one processing core, at least one memory including computer program code, the at least one memory and the computer program code being configured to, with the at least one processing core, cause the apparatus at least to receive, from a first network element, a second share of a private key associated with a terminal, receive a message via a blockchain, from a second network element, comprising an indication that an investigation has started related to the terminal and transmit, to the second network element, the second share of the private key associated with the terminal.

According to a fourth aspect of the present invention, there is provided a first method, comprising, generating a first and a second share of a private key associated with a terminal, generating a moduli-set associated with the terminal, transmitting the first share to a second network element and the second share to a third network element, receiving via a blockchain, from the second network element, a message comprising an indication that an investigation has started related to the terminal and transmitting the moduli-set associated with the terminal to the second network element.

According to a fifth aspect of the present invention, there is provided a second method, comprising, receiving, from a first network element, a first share of a private key associated with a terminal, transmitting a message, comprising an indication that an investigation has started related to the terminal, to a blockchain, receiving, from a third network element, a second share of the private key associated with the terminal, receiving, from the first network element, a moduli-set associated with the terminal, reconstructing the private key using the first and the second share of the private key and decrypting a password associated with the terminal using the private key and the moduli-set.

According to a sixth aspect of the present invention, there is provided a third method, comprising, receiving, from a first network element, a second share of a private key associated with a terminal, receiving via a blockchain, from a second network element, a message comprising an indication that an investigation has started related to the terminal and transmitting, to the second network element, the second share of the private key associated with the terminal.

According to a seventh aspect of the present invention, there is provided an apparatus comprising means for performing the first method. According to an eighth aspect of the present invention, there is provided an apparatus comprising means for performing the second method. According to a ninth aspect of the present invention, there is provided an apparatus comprising means for performing the third method.

According to a tenth aspect of the present invention, there is provided a non-transitory computer readable medium having stored thereon a set of computer readable instructions that, when executed by at least one processor, cause an apparatus to at least to perform the first method. According to an eleventh aspect of the present invention, there is provided a non-transitory computer readable medium having stored thereon a set of computer readable instructions that, when executed by at least one processor, cause an apparatus to at least to perform the second method. According to a twelfth aspect of the present invention, there is provided a non-transitory computer readable medium having stored thereon a set of computer readable instructions that, when executed by at least one processor, cause an apparatus to at least to perform the third method.

According to a thirteenth aspect of the present invention, there is provided a computer program configured to cause a method in accordance with the first, second or third method.

### BRIEF DESCRIPTION OF THE DRAWINGS

FIG. 1 illustrates a network scenario in accordance with at least some embodiments of the present invention;

FIG. 2 illustrates a process and signalling in accordance with at least some embodiments of the present invention;

FIG. 3 illustrates an example apparatus capable of supporting at least some embodiments of the present invention;

FIG. 4 illustrates a flow graph of a first method in accordance with at least some embodiments of the present invention; and

FIG. 5 illustrates a flow graph of a second method in accordance with at least some embodiments of the present invention.

FIG. 6 illustrates a flow graph of a third method in accordance with at least some embodiments of the present invention.

### EMBODIMENTS

Embodiments of the present invention relate to providing methods, apparatuses and computer programs, which enable access to personal devices of suspicious users while ensuring justified and controlled access to the personal devices. Justified and controlled access to the personal devices may be achieved by enabling public control, to avoid misuse of personal devices, e.g., by law-enforcement agencies and justice departments. Hence privacy of certain users may be guaranteed as well.

One challenge addressed by the present invention is how to enable controlled access to a device that belongs, e.g., to a criminal or terrorist without sacrificing privacy of other users. At the same it should be possible to check that there is no misuse by certain participants, such as, for example, by law-enforcement agencies and justice departments.

In general, for example big device manufacturers may not be able to provide governments with legal access to customer data without compromising personal privacy, and even national security. Thus according to some embodiments of the present invention, there is provided a complete framework for a trusted society, where access to personal devices of users is possible, but under control. So, e.g., in case of criminal activity some authorities may have the ability to access sensitive data of the users. However, this access may be verifiable by everyone, or at least by authorized parties. Therefore some control may be performed in case of potentially misbehaving authorities.

Moreover, various manufacturers may select to encrypt their devices, such as, for example, mobile phones or tablets, differently. It may also be difficult to predict how various device manufacturers around the world would behave, because the subject is sensitive and each country may exert control over the manufacturers at a higher or smaller degree. Some device manufacturers may say, for example, that they cannot provide access to encrypted data of personal devices.

In some embodiments of the present invention, a key pair, comprising a public key and a private key associated with a device, may be used for encryption of a password of the device when a user of the device sets the password. More specifically, the public key of the key pair may be used for encryption. The key pair may be generated, or originated, by a manufacturer of the device. So if the device needs to be decrypted, the manufacturer or another authorized party, such as, for example, a law-enforcement agency or justice department, may decrypt the device using the private key.

In addition, some embodiments of the present invention provide means for addressing concerns of society on whether authorities or manufacturers may misbehave and try to decrypt devices in an unlawful manner. Thus people, or at least authorized parties, may have control on the process so that the user cannot be easily bypassed by the authorities. According to some embodiments of the present invention, techniques from cryptography and blockchain-technology may be applied to provide a trusted way for unlocking of devices, wherein control over the authorities is enabled while providing transparency to all transactions.

In general, blockchains may be applied for recording transactions without relying to a centralized entity. Changes in resource ownership in a blockchain network take the form of blockchain transactions secured by strong cryptography. Information provided in a blockchain transaction may be stored as a new block in the blockchain in response to validation of the respective blockchain transaction. Blockchain state information shared by the nodes may store all transactions and history carried out in the blockchain network. Application of blockchain technology and a ledger may enable a way to track the unique history of transactions by the individual nodes in the network. Modifying transaction data stored in a blockchain is very difficult, since as the chain lengthens, the data is left ever deeper in the blockchain.

Blockchains may be used to provide a completely auditable log that includes every single transaction ever done in a blockchain network, which may be very useful in a number of use cases. However, due to this nature, scalability of blockchains is affected by their ever-growing size due to new transactions.

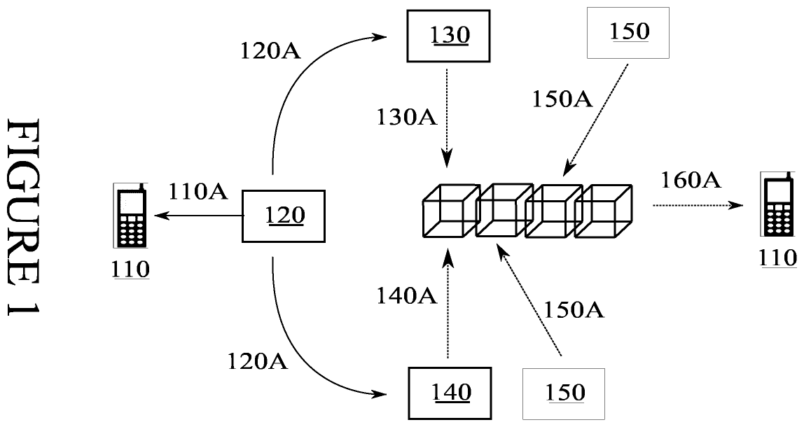

FIG. 1 illustrates a network scenario in accordance with at least some embodiments of the present invention. As shown in FIG. 1, the network scenario may comprise device 110, such as, for example, a user equipment, mobile phone, tablet or any other end-user device. According to some embodiments of the present invention encryption/decryption of device 110 may need to be regulated. The network scenario may also comprise first network element 120, which may be connected, at least temporarily, to device 110 via interface 110A.

First network element 120 may be responsible for distribution of shares, or parts, of a private key associated with device 110. In some embodiments first network element 120 may be associated with a manufacturer of device 110, or controlled by the manufacturer of device 110. The shares may be distributed among a group of participants, i.e., each participant may be allocated a share of the secret. The secret may be reconstructed only using a combination of a sufficient number of shares, i.e., any of the participants may not reconstruct the secret by itself. This may be referred to as secret sharing, or secret splitting. In some embodiments of the present invention all of the shares may be required for reconstructing the secret.

The group of participants may comprise at least second network element 130 and third network element 140. First network element 120 may be connected to second network element 130 and third network element 140 via interfaces 120A. In some embodiments second network element 130 may be associated with a law-enforcement agency or controlled by the law-enforcement agency. Alternatively, or in addition, in some embodiments third network element 140 may be associated with a justice authority or controlled by the justice authority. The group of participants may also comprise other network elements. For example, the group of participants may comprise multiple second network elements, each associated with a different law-enforcement agency. Alternatively, or in addition, the group of participants may comprise multiple third network elements, each associated with a different justice authority. The group of participants may also comprise one or more fourth network elements 150.

Second network element 130 may use the received secret share together with at least one other share, via interface 130A, to access device 110. Similarly, third network element 140 may use the received secret share together with at least one other share, via interface 130A, to access device 110.

According to some embodiments of the present invention there may also be one or more fourth network elements 150. At least one fourth network element 150 may be a part of a peer-to-peer network used to manage a blockchain. In some embodiments, the at least one fourth network element may refer to a law representative, such as, a lawyer, or be controlled by the law representative. Hence in some embodiments of the present invention fourth network element 150 may be referred to as a blockchain peer. The blockchain may be associated with one device 110 only, or possibly with multiple devices.

According to at least some embodiments of the present invention, device 110 may be manufactured first. Device 110 may be associated with at least two cryptographic keys, comprising a public and a private key, by first network element 120. For example, device 110 may be associated with the at least two cryptographic keys during the manufacturing process of device 110. Device 110 may be encrypted, for example, by a user via a key derived from the encryption of a user password using the public key.

First network element 120 may compute at least two crypto-elements, e.g., shares of the private key, which may be needed for decryption of device 110. First network element 120 may transmit the at least two crypto-elements to second and third network elements. That is to say, in some embodiments the manufacturer may compute the at least two crypto-elements and transmit those to a law-enforcement agency and justice authority. In some embodiments, transmission of the at least two crypto-elements may be recorded within the blockchain for providing non-deniability of the transmitted crypto-elements.

An investigation may be started regarding device 110. In such a case a request may be transmitted within the blockchain. In some embodiments, the request may be broadcasted. This notifies, e.g., the law-enforcement and justice authorities. Consequently they may be able to verify if the new investigation abides to current regulations. An investigation may be initiated by a court of law or delegated authority, for example.

If nobody complains about the investigation, the manufacturer, the law-enforcement agency and the justice authority/department for example may provide, e.g., to each other, their own crypto-elements/shares associated with device 110 to make the decryption possible. Thus device 110 may be decrypted, e.g., the user password may be decrypted and the device may be accessed.

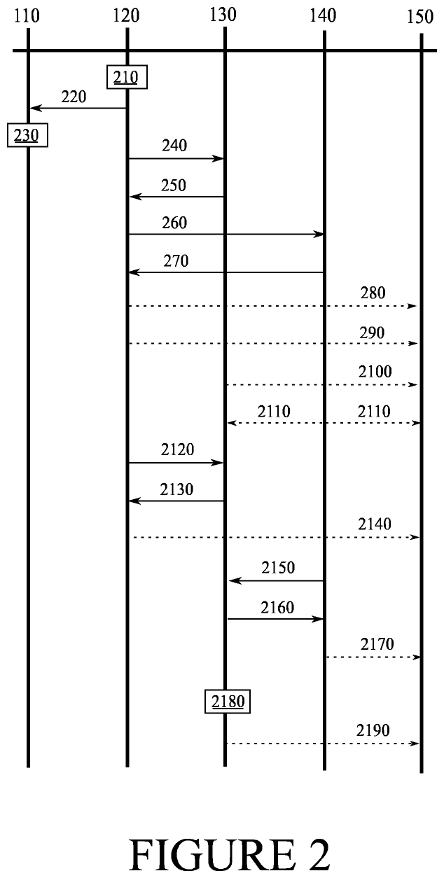

FIG. 2 illustrates a process and signalling in accordance with at least some embodiments of the present invention. Messages transmitted to a blockchain, i.e., to blockchain peers, are denoted by dashed lines in FIG. 2 and unicast messages, i.e., messages transmitted to a certain destination, are denoted by solid lines. On the vertical axes are disposed, from the left to the right, device 110, first network element 120, second network element 130, third network element 140 and at least one fourth network element 150, i.e., blockchain peer, of FIG. 1. In general, in FIG. 2 the blockchain is represented by block 150. Time advances from the top toward the bottom.

The process may start, at step 210, when first network element 120 may generate a pair of public-private keys (P, Q) for device 110, associated with identity of device 110. Identity of device 110 may be denoted by ID. First network element 120 may also calculate hash values H(P) and H(Q) for the generated private-public keys P and Q, respectively. Moreover, first network element may also create at least two shares of the secret, private key Q.

In some embodiments a Secure Secret Sharing scheme, SSS, may be used. As an example, SSS may be based on Chinese Remainder Theorem, CRT. The CRT may be based on a set of relatively prime integers (m₁, m₂, . . . , mₙ), which may be referred to as a moduli-set. In some embodiments, a range of this system may be defined as the product of all of the integers of the moduli-set, i.e., M=m₁·m₂· . . . ·mₙ. Any integer X in the range [0, M−1] may be represented uniquely as a set of smaller integers (x₁, x₂, . . . , xₙ), where each x₁=X mod mᵢ. The CRT may be used to assure that the integer X can be reconstructed correctly from its residue representation (x₁, x₂, . . . xₙ). Moreover, in some embodiments of the present invention other methods may be used for reconstructing an integer from its residues as well. For example, Mixed-Radix Conversion may be exploited for reconstructing an integer from its residues as well.

Generally speaking, SSS is a cryptographic protocol that enables sharing of a valuable secret to different stakeholders/participants. SSS does not allow stakeholders/participants to retrieve the full secret from their own share, but instead a collusion of stakeholders/participants is required to reconstruct the secret. That is to say, in some embodiments of the present invention at least two network elements, i.e., stakeholders/participants, may obtain a share of the secret. In some embodiments the secret may be the private key Q. The share of the secret may be referred to as a part, or portion, of the private key Q.

In general, it may not be possible to retrieve a full secret from a portion, or share, of the secret. Instead, all portions of the secret, or at least some of those, may be required for retrieving the full secret. According to some embodiments of the present invention, first network element 120, e.g., a manufacturer of device 110, may share a first part/share of the private key Q with second network element 130, e.g., a law-enforcement agency, and a second part/share of the private key Q with third network element 140, e.g., a justice department. In some embodiments, there may be more than two shares of the private key Q, which may be shared by first network element 120 with other network elements than second network element 130 and third network element 140.

In an embodiment, first network element 120 may define, or generate, a moduli-set associated with device 110. The moduli-set may be required by CRT-SSS. In some embodiments, the moduli-set may comprise relatively co-prime integers. Moreover, in some embodiments the moduli-set may be denoted by (m₁, . . . , mₙ). First network element may also create, or generate, the residue representation (q₁, . . . , qₙ) of the secret key Q via the rule qᵢ=Q mod mᵢ and then split those residues in groups (shares) of the secret key Q. The moduli-set may be used for creating, or generating, the shares of the secret key Q.

At step 220, first network element 120 may install the public key P to device 110. Consequently, if a password, or a passcode, is set by a user of device 110, a device key K_{D} may be generated by encrypting the password, or the passcode, with the public key P. Thus, if the password is denoted by pwd, the device key K_{D} may be formulated as K_{D}=ENC(P,pwd). Then, at step 230, a file-system of device 110 may be encrypted using the device key K_{D}.

First network element 120 may compute a hash of a first created share for second network element 130 and transmit, at step 240, a message comprising residues of the first created share, qᵢ, the hash of the residues of the first created share, H(qᵢ), and the identity of device 110, ID, to second network element 130. In some embodiments, the message transmitted at step 240 may be denoted by Share(ID, qᵢ, H(qᵢ)).

Second network element 130 may, at step 250, acknowledge reception of the message, received at step 240, by transmitting a first acknowledgement message to first network element 120. The first acknowledgement message may comprise a hash, which may be calculated by second network element 130 over the received first created share. In some embodiments, second network element may also sign the hash and embed the signature to the first acknowledgement message. The first acknowledgement message may further comprise the identity of device 110. In some embodiments, the first acknowledgement message may be denoted by ACK_{LE}(ID, H(qᵢ), SIG(H(qᵢ))). Thus, second network element 130 may calculate its own hash over qᵢ, which should be the same as the hash received from first network element 120, to ensure and confirm that there has been no change along the way.

Similarly, first network element 120 may compute a hash of a second created share for third network element 140 and transmit, at step 260, a message comprising residues of the second created share, the hash of the residues of the second created share, H(qⱼ), and the identity of device 110, ID, to third network element 140. In some embodiments, the message transmitted at step 260 may be denoted by Share(ID, H(qⱼ)).

Third network element 140 may, at step 270, acknowledge reception of the message, received at step 260, by transmitting a second acknowledgement message to first network element 120. The second acknowledgement message may comprise a hash, which may be calculated by third network element 140 over the received second created share. In some embodiment third network element may also sign the hash and embed the signature to the second acknowledgement message. The second acknowledgement message may further comprise the identity of device 110, and be denoted by ACK_{J}(ID, H(qⱼ), SIG(H(qⱼ)).

Hence second network element 130 and third network element 140 may not be able to dispute reception of the first and second shares, respectively. On the other hand, second and third network elements may prove the reception of the first and second shares, respectively, if first network element denies transmissions of the first and second shares, because the first and the second acknowledgement messages may be included to a notification about availability of a new device (at step 290).

Upon reception of the first and second acknowledgements, at steps 250 and 270, first network element may delete the key pair (P, Q) and transmit a notification about deletion of the key pair (P, Q) to the blockchain, at step 280. Consequently, second network element 130, third network element 140 and/or at least one fourth element may get the information about deletion of the key pair via the blockchain. The notification about deletion of the key pair may comprise identity of device 110, hash of the public key P and hash of the private key Q. In some embodiment the notification about deletion of the key pair may be denoted by DeleteKey(ID, H(P), H(Q)).

Hence the burden of first network element 120, e.g., a manufacturer, may be reduced, because it does not have to hold the key pair (P, Q). Moreover, since the notification about deletion of the key pair may be transmitted to the blockchain, it is verifiable, and first network element 120 would violate the blockchain by not deleting the key pair. Consequently, blockchain peers would raise a flag. Therefore this also makes it possible to deprive first network element 120 of completely bypassing the system and accessing, or granting access, to device 110 in an unlawful manner.

According to some embodiments of the present invention, the transmission of the notification, or any other transmission, to the blockchain refers to linking the current transmission, i.e., block, to a previous block in the blockchain. Alternatively, one block may comprise, for example, a large number of transmissions. For example, a first block of the blockchain may comprise the secret, private key Q or its hash. Thus, the transmission of the notification to the blockchain may be seen as a transaction that is added to the blockchain. A block in the blockchain may comprise a block ID, hash of the previous block and the transaction or transactions of the block.

Moreover, in some embodiments of the present invention a private blockchain may be used. The private blockchain may operate in the same way as public ones, except that in case of private blockchains only authorized users, or network elements, may have visibility over the transactions. Hence, for example, a manufacturer of device 110, at least one law-enforcement agency, at least one justice department and at least one fourth network element may be authorized users and control the transactions. Referring to FIG. 2, the broadcasted messages, represented by dashed lines, demonstrate messages that may be broadcasted to the blockchain.

Upon reception of the acknowledgements, at steps 250 and 270, and transmitting the notification about deletion of the key pair (P, Q) to the blockchain, at step 280, first network element 120 may transmit a notification about availability of a new device, i.e., device 110, to the blockchain at step 290. Consequently, second network element 130, third network element 140 and/or at least one fourth element may get the information about availability of the new device via the blockchain. The notification about availability of a new device may comprise identity of device 110, the first acknowledgement message and the second acknowledgement message. The identity of the device may comprise an international mobile equipment identity, IMEI, or a serial number, for example. In some embodiments the notification about deletion of the key pair may be denoted by NewDevice(ID, ACK_{LE}, ACK_{J}).

At step 2100, second network element 130, e.g., a law-enforcement agency, may transmit an indication that an investigation has been initiated for device 110 to the blockchain. In some embodiments the indication may comprise the identity of device 110 and it may be denoted by InvestigationStarted(ID). Moreover, in some embodiments, third network element 140, e.g., a justice department or any other entity serving as a trust anchor point, such as a fourth network element which is an authenticated user, may transmit an abort message to second network element 130 and to the blockchain 150, at step 2110. This is to allow the, e.g., law representatives to stop the blockchain process in case they feel the rights of their clients are violated. The blockchain process ends if the abort message is sent and after that the normal investigation procedures defined by the law are followed. The abort message may comprise an identity of device 110 and it may be denoted by Abort(ID

In some embodiments there may be a time period, which is possibly fixed, and during that time other authorized users for the blockchain, such as, for example, other governmental parties or lawyers may raise a claim of misuse or mishandling of the case by first network element 120 (e.g., a manufacturer of device 110) or second network element 130 (e.g., a law-enforcement agency) by transmitting an abort message. So for example, third network element 140 may start a timer for the time period upon receiving the indication that an investigation has been initiated for device 110, at step 2100. Similarly, first network element 120 may start a timer for the time period upon receiving the indication that an investigation has been initiated for device 110, at step 2100.

Upon expiry of the time period, and if there was no abort message, first network element 120 may transmit to second network element 130, at step 2120, the moduli-set that were used to generate the first and second shares of the private key Q at step 210. However, the process ends if an abort message is received while the timer is running, i.e., within the time period.

Transmission of the moduli-set may comprise the moduli-set and a first nonce. In general, in the context of cryptography a nonce may be referred to as an arbitrary number, which may be used only once. Hence a nonce may be used for making sure that old communications cannot be exploited again, e.g., in case of replay attacks. In some embodiments of the present invention the transmission of the moduli-set may be denoted by Moduli(Nonce1, {₁, . . . , mₖ), where k≤n.

Consequently, second network element 130 may acknowledge reception of the moduli-set by transmitting a third acknowledgement message at step 2130. The third acknowledgement message may comprise a signature of second network element 130, associated with the received moduli-set. In some embodiments of the present invention, the third acknowledgement message may be referred to as ACK_{mod}(SIG(Moduli( . . . ))).

Upon reception of the third acknowledgement message from second network element 130, first network element 120 may transmit an indication regarding the third acknowledgement message, at step 2140, to the blockchain. In some embodiments, the indication regarding the third acknowledgement message may be referred to as proof of sharing the moduli. The indication may be transmitted to the blockchain. The indication may be denoted by ProofOfSharing(ACK_{mod}).

A similar process may be conducted by third network element 140 towards second network element. Upon expiry of the time period, and if there was no abort message, third network element 140 may transmit to second network element 130, at step 2150, the second share of the private key Q, at step 260. Transmission of the second share of the private key Q may comprise a second nonce in addition to the second share. In some embodiments, the transmission of the second share of the private key Q may be referred to as Share(Nonce2, qⱼ).

Consequently, second network element 130 may acknowledge reception of the second share of the private key Q by transmitting a fourth acknowledgement message at step 2160. The fourth acknowledgement message may comprise a signature of second network element 130, associated with the received the second share. In some embodiments of the present invention, the fourth acknowledgement message may be referred to as ACKₛₕₐᵣₑ(SIG(Share( . . . ))).

Upon reception of the fourth acknowledgement message from second network element 130, third network element 140 may transmit an indication regarding the fourth acknowledgement message, at step 2170, to the blockchain. In some embodiments, the indication regarding the fourth acknowledgement message may be referred to as proof of sharing the second share of the private key Q. The indication may be transmitted to the blockchain. The indication may be denoted by ProofOfSharing(ACKₛₕₐᵣₑ).

Furthermore, upon reception of the moduli, at step 2120, and the second share of the private key, at step 2150, second network element 140 may use the first and the second secret share together with the moduli-set to reconstruct the secret, private key Q with the use of, for example, the CRT, at step 2180. Reconstructing may be denoted by Reconstruct Q=CRT(qᵢ,qⱼ) according to

$$CRT ( {q}_{i} , {q}_{j} ) = ( {\sum }_{i = 1}^{k} {〈 {q}_{i} {M}_{i}^{- 1} 〉}_{{m}_{i}} \cdot {M}_{i} ) m o d M$$

where M is the range of the system of the moduli-set (m₁, m₂, . . . , mₙ), Mᵢ=M/mᵢ and M⁻¹ᵢ is the modular inverse of the Mᵢ mod mᵢ. The notation [symbol] · [symbol] mᵢ refers to the operation (·)mod mᵢ. Moreover, second network element may also decrypt the password of the user, associated with device 110, using the reconstructed secret key Q and K_{D}, which may be denoted by pwd=DEC(Q, K_{D}).

After step 2180, second network element 130 may close the investigation and transmit to the blockchain an indication that the investigation has ended, at step 2190. Second network element 130 may end the process this way and ensure that the process does not remain open indefinitely.

The present invention addresses various challenges and provides various benefits. For example, embodiments of the present invention make it impossible for second network element 130 to deny that it has started a decryption process related to device 110. Moreover, second network element 130 may not deny reception of the first and second shares of the private key Q, or the moduli. Second network element 130 may not delay the process as much as needed to invalidate it either. In addition, first network element 120 may not deny distribution of the first and second shares of the private key Q. First network element 120 may not serve as the sole holder of the keys either.

According to at least some embodiments of the present invention, the process does not depend solely on first network element 120. In fact, a single point of failure may be avoided, because key escrow is strengthened by using the secret key sharing. The process may be transparent to the blockchain and even authorized users, such as, for example, lawyers, may have the ability to interfere if they feel rights of their clients may be violated. Hence fairness may be achieved, because parties that do not belong to any of law-enforcement/justice/government may have some control over the process in any case.

Furthermore, the process may be immutable and indisputable, which empowers trust into the legal/law-enforcement activities Also, it may be used to allow intra-country cooperation and participation in the same blockchain. For example, the process may be used for preventing unauthorized prosecution and device access for citizens that travel in other countries, without respecting the rights of the citizen's homeland. Hence embodiments of the present invention enable a global system of trust of countries that participate in the process, which may be used to gain credibility and trust from the people, as they allow their investigation methods to be open to the blockchain.

In some embodiments of the present invention, device 110 may not reveal anything for a suspect. In such a case, a manufacturer of device 110 may individually update the key pair of device 110 (referring to steps 210 and 220 in FIG. 2) because device 110 has been compromised and hence may need to be updated with a new key before it is returned to the end-user.

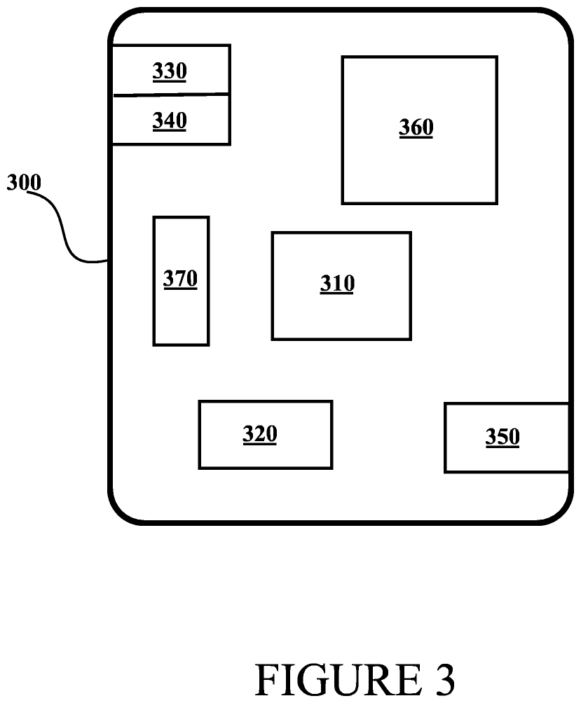

FIG. 3 illustrates an example apparatus capable of supporting at least some embodiments of the present invention. Illustrated is device 300, which may comprise, for example, device 110, such as, a mobile communication device, first network element 120, second network element 130 or third network element 140 of FIG. 1 or FIG. 2. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. Processor 310 may be a control device. A processing core may comprise, for example, a Cortex-A8 processing core manufactured by ARM Holdings or a Steamroller processing core produced by Advanced Micro Devices Corporation. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310 may be means for performing method steps in device 300. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300.

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker and a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

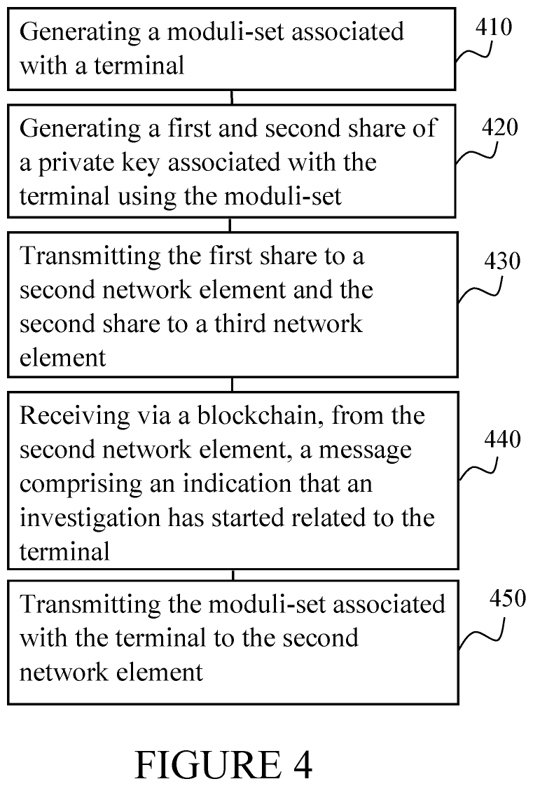

FIG. 4 is a flow graph of a first method in accordance with at least some embodiments of the present invention. The phases of the illustrated first method may be performed by first network element 120 or by a control device configured to control the functioning thereof, possibly when installed therein.

The first method may comprise, at step 410, generating a first and a second share of a private key associated with a device. In addition, the first method may comprise, at step 420, generating a moduli-set associated with the device. The first method may also comprise, at step 430, transmitting the first share to a second network element, for example to second network element 130 of FIG. 1 and/or FIG. 2, and the second share to a third network element, for example to third network element 140 of FIG. 1 and/or FIG. 2. Moreover, the first method may comprise, at step 440, receiving via a blockchain, from the second network element, a message comprising an indication that an investigation has started related to the device and, at step 450, transmitting the moduli-set associated with the device to the second network element.

In an embodiment, the first method may also comprise deleting a key pair, comprising a public key and the private key, associated with the device upon receiving a first acknowledgment message from the second network element and a second acknowledgement message from the third network element and transmitting a notification about deletion of the key pair associated with the device to a blockchain.

Alternatively, or in addition, the first method may comprise transmitting a notification about availability of the device to a blockchain. The notification about availability of the device may be transmitted to the blockchain upon deleting a key pair associated with the device, wherein the key pair comprises a public key and the private key.

In an embodiment, the first method may comprise receiving a third acknowledgement message from the second network element in response to transmitting the moduli-set associated with the device.

In an embodiment, the first method may comprise transmitting an indication, to a blockchain, regarding sharing of the moduli-set associated with the device upon receiving the third acknowledgement from the third network element.

In an embodiment, the first method may comprise receiving an indication via a blockchain, from the second network element, that the investigation has ended.

In an embodiment, the first method may comprise generating a key pair, comprising a public key and the private key, associated with the device and generating the first and a second share of the private key associated with a device based on the private key. Alternatively, or in addition, the first method may comprise installing the public key associated with the device to the device.

In an embodiment, the first method may comprise receiving a first acknowledgement message, from the second network element, in response to transmitting the first secret share to the second network element and receiving a second acknowledgement message, from the third network element, in response to transmitting the second secret share to the third network element.

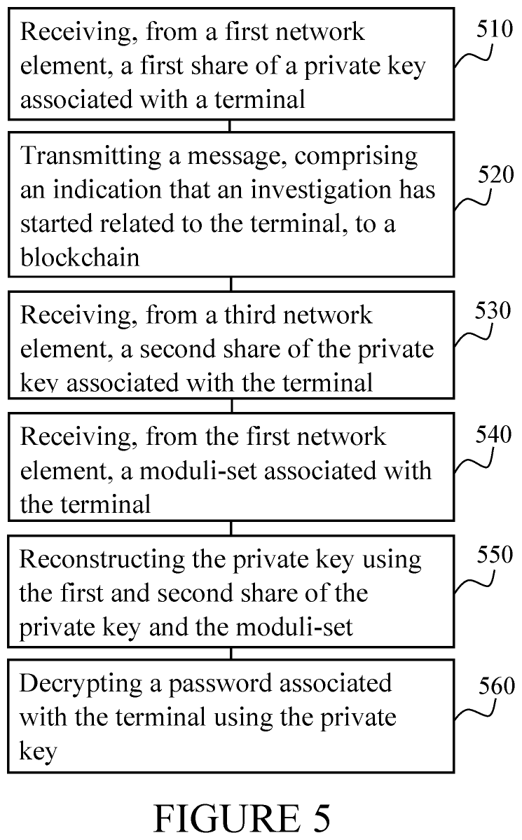

FIG. 5 is a flow graph of a second method in accordance with at least some embodiments of the present invention. The phases of the illustrated second method may be performed by second network element 130 or by a control device configured to control the functioning thereof, possibly when installed therein.

The second method may comprise, at step 510, receiving a first share of a private key associated with a device from a first network element. In addition, the second method may comprise, at step 520, transmitting a message, comprising an indication that an investigation has started related to the device, to a blockchain. The second method may also comprise, at step 530, receiving a second share of the private key associated with the device from a third network element. Moreover, the second method may also comprise, at step 540, receiving a moduli-set associated with the device from the first network element. At step 550, the second method may comprise reconstructing the private key using the first and the second share of the private key and, at step 560, decrypting a password associated with the device using the private key and the moduli-set.

In an embodiment, the second method may comprise transmitting a first acknowledgement message, to the first network element, in response to receiving the first share of the private key from the first network element.

In an embodiment, the second method may comprise receiving, via a blockchain, a notification about deletion of a key pair, comprising a public key and the private key, associated with the device.

In an embodiment, the second method may comprise transmitting a third acknowledgement message to the first network element in response to receiving the moduli-set associated with the device.

In an embodiment, the second method may comprise receiving a notification, from the first network element, about availability of the device via a blockchain.

In an embodiment, the second method may comprise receiving an indication, from the first network element, regarding sharing of the moduli-set associated with the device upon transmitting the third acknowledgement to the first network element.

In an embodiment, the second method may comprise transmitting an indication, to a blockchain, that the investigation has ended upon decrypting the password associated with the device.

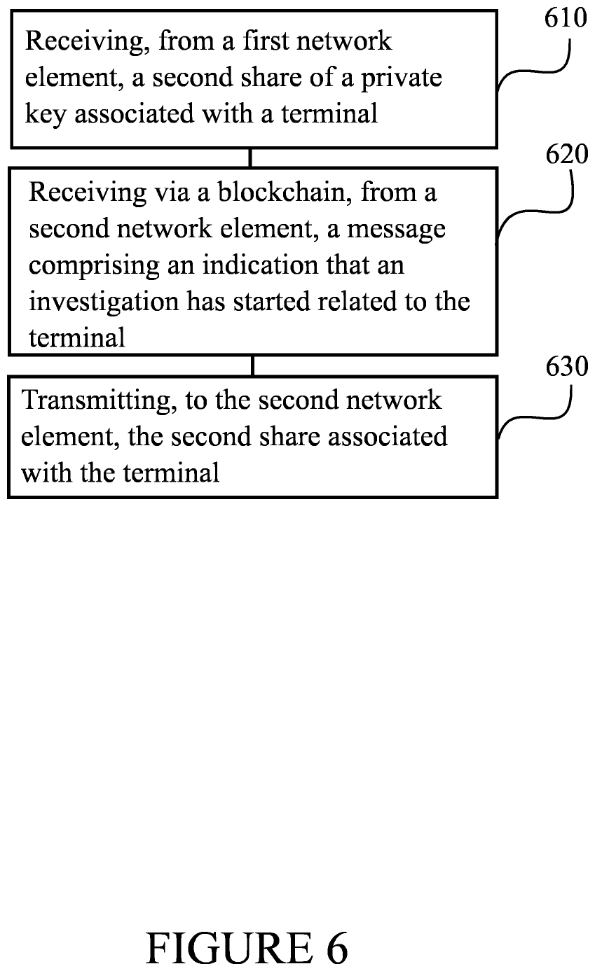

FIG. 6 is a flow graph of a third method in accordance with at least some embodiments of the present invention. The phases of the illustrated third method may be performed by third network element 140 or by a control device configured to control the functioning thereof, possibly when installed therein.

The third method may comprise, at step 610, receiving, from a first network element, a second share of a private key related to a device. In addition, the third method may comprise, at step 620, receiving via a blockchain, from a second network element, a message comprising an indication that an investigation has started related to the device. The third method may also comprise, at step 630, transmitting, to the second network element, the second share of the private key associated with the device.

In an embodiment, the third method may comprise transmitting a second acknowledgement message, to the first network element, in response to receiving the second share of the private key.

In an embodiment, the third method may comprise receiving a notification, from the first network element, about availability of the device via a blockchain. Alternatively, or in addition, the third method may comprise receiving an indication via the blockchain, from the first network element, regarding sharing of the moduli-set associated with the device.

In an embodiment, the third method may comprise receiving a fourth acknowledgement from the second network element in response to transmitting the second share of the private key associated with the device to the third network element.

In an embodiment, the third method may comprise transmitting an indication, to the blockchain, regarding sharing of the second share of the private key associated with the device upon receiving a fourth acknowledgement from the second network element.

In an embodiment, the third method may comprise starting a timer for a time period upon receiving the indication that an investigation has been initiated for device and, when no abort message is received within the time period, performing the transmitting of the second share of the private key associated with the device to the second network element upon expiry of the time period.

In an embodiment, the third method may comprise receiving an indication, from the second network element, that the investigation has ended via a blockchain.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

In an exemplary embodiment, an apparatus, such as, for example, first network element 120, second network element 130 or third network element 140, may comprise means for carrying out the embodiments described above and any combination thereof.

In an exemplary embodiment, a computer program may be configured to cause a method in accordance with the embodiments described above and any combination thereof. In an exemplary embodiment, a computer program product, embodied on a non-transitory computer readable medium, may be configured to control a processor to perform a process comprising the embodiments described above and any combination thereof.

In an exemplary embodiment, an apparatus, such as, for example, first network element 120, second network element 130 or third network element 140, may comprise at least one processor, and at least one memory including computer program code, wherein the at least one memory and the computer program code are configured to, with the at least one processor, cause the apparatus at least to perform the embodiments described above and any combination thereof.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

### INDUSTRIAL APPLICABILITY

At least some embodiments of the present invention find industrial application in communication networks, wherein access to devices needs to be enabled. For example, law-enforcement agencies and justice departments may sometimes need a way to access a device in a communication network, but at the same time misuse of personal devices should be avoided.

### ACRONYMS LIST

### CRT Chinese Reminder Theorem

### SSS Secure Secret Sharing

REFERENCE SIGNS LIST

| | |
|---|---|
| 110 | Device |
| 120 | First network element, e.g., |
| | controlled by a manufacturer |
| | of device 110 |
| 120A, 130A, | Interfaces |
| 140A, 150A, | |
| 160A | |
| 130 | Second network element, e.g., |
| | controlled by a law-enforcement |
| | agency |
| 140 | Third network element, e.g., |
| | controlled by a justice authority |
| 150 | Fourth network element, e.g., |
| | a blockchain peer |
| 210, 230, | Processing steps in FIG. 2 |
| 2180 | |
| 220, 240- | Signaling steps in FIG. 2 |
| 2170, 2190 | |
| 300-370 | Structure of the apparatus of FIG. 3 |
| 410-450 | Phases of the method of FIG. 4 |
| 510-560 | Phases of the method of FIG. 5 |
| 610-630 | Phases of the method of FIG. 6 |

1. An apparatus comprising at least one processing core, at least one memory including computer program code, the at least one memory and the computer program code being configured to, with the at least one processing core, cause the apparatus at least to:
generate a moduli-set associated with a terminal;
generate a first and a second share of a private key associated with the terminal using the moduli-set;
transmit the first share to a second network element and the second share to a third network element;
receive via a blockchain, from the second network element, a message comprising an indication that an investigation has started related to the terminal; and
transmit the moduli-set associated with the terminal to the second network element.

2. An apparatus according to claim 1, wherein the at least one processing core, the at least one memory including computer program code, the at least one memory and the computer program code being configured to, with the at least one processing core, further cause the apparatus at least to:
delete a key pair, comprising a public key and the private key, associated with the terminal upon receiving a first acknowledgment message from the second network element and a second acknowledgement message from the third network element; and
transmit a notification about deletion of the key pair associated with the terminal to the blockchain.

3. An apparatus according to claim 1, wherein the at least one processing core, the at least one memory including computer program code, the at least one memory and the computer program code being configured to, with the at least one processing core, further cause the apparatus at least to:
transmit a notification about availability of the terminal to the blockchain upon deleting a key pair associated with the terminal, wherein the key pair comprises a public key and the private key.

4. An apparatus according to claim 1, wherein the at least one processing core, the at least one memory including computer program code, the at least one memory and the computer program code being configured to, with the at least one processing core, further cause the apparatus at least to:
receive a third acknowledgement message from the second network element in response to transmitting the moduli-set associated with the terminal.

5. An apparatus according to claim 4, wherein the at least one processing core, the at least one memory including computer program code, the at least one memory and the computer program code being configured to, with the at least one processing core, further cause the apparatus at least to:
transmit an indication, to the blockchain, regarding sharing of the moduli-set associated with the terminal upon receiving the third acknowledgement from the second network element.

6. An apparatus according to claim 1, wherein the at least one processing core, the at least one memory including computer program code, the at least one memory and the computer program code being configured to, with the at least one processing core, further cause the apparatus at least to:
start a timer for a time period upon receiving the indication that an investigation has been initiated for the terminal; and
when no abort message is received within the time period, perform the transmitting of the moduli-set associated with the terminal to the second network element upon expiry of the time period.

7. An apparatus according to claim 1, wherein the at least one processing core, the at least one memory including computer program code, the at least one memory and the computer program code being configured to, with the at least one processing core, further cause the apparatus at least to:
receive an indication via the blockchain, from the second network element, that the investigation has ended.

8. An apparatus comprising at least one processing core, at least one memory including computer program code, the at least one memory and the computer program code being configured to, with the at least one processing core, cause the apparatus at least to:
receive, from a first network element, a first share of a private key associated with a terminal;
transmit a message, comprising an indication that an investigation has started related to the terminal, to a blockchain;
receive, from a third network element, a second share of the private key associated with the terminal;
receive, from the first network element, a moduli-set associated with the terminal, the moduli-set having been used to generate the first and second shares of the private key;
reconstruct the private key using the first and the second share of the private key and the moduli-set; and
decrypt a password associated with the terminal using the private key.

9. An apparatus comprising at least one processing core, at least one memory including computer program code, the at least one memory and the computer program code being configured to, with the at least one processing core, cause the apparatus at least to:
receive, from a first network element, a second share of a private key associated with a terminal;
receive a message via a blockchain, from a second network element, comprising an indication that an investigation has started related to the terminal; and
transmit, to the second network element, the second share of the private key associated with the terminal.

10. A method, comprising:
generate a moduli-set associated with a terminal;
generating a first and a second share of a private key associated with the terminal using the moduli-set;
transmitting the first share to a second network element and the second share to a third network element;
receiving via a blockchain, from the second network element, a message comprising an indication that an investigation has started related to the terminal; and
transmitting the moduli-set associated with the terminal to the second network element.

11. A method according to claim 10, further comprising:
deleting a key pair, comprising a public key and the private key, associated with the terminal upon receiving a first acknowledgment message from the second network element and a second acknowledgement message from the third network element; and
transmitting a notification about deletion of the key pair associated with the terminal to the blockchain.

12. A method according to claim 10, further comprising:
transmitting a notification about availability of the terminal to the blockchain upon deleting a key pair associated with the terminal, wherein the key pair comprises a public key and the private key.

13. A method according to claim 10, further comprising:
receiving a third acknowledgement message from the second network element in response to transmitting the moduli-set associated with the terminal.

14. A method according to claim 13, further comprising:
transmitting an indication, to the blockchain, regarding sharing of the moduli-set associated with the terminal upon receiving the third acknowledgement from the second network element.

15. A method according to claim 10, further comprising:
starting a timer for a time period upon receiving the indication that an investigation has been initiated for terminal; and
when no abort message is received within the time period, performing the transmitting of the moduli-set associated with the terminal to the second network element upon expiry of the time period.

16. A method according to claim 10, further comprising:
receiving an indication via the blockchain, from the second network element, that the investigation has ended.

17. A non-transitory computer readable medium having stored thereon a set of computer readable instructions that, when executed by at least one processor, cause an apparatus to at least:
generate a moduli-set associated with the terminal;
generate a first and a second share of a private key associated with the terminal using the moduli-set;
transmit the first share to a second network element and the second share to a third network element;
receive via a blockchain, from the second network element, a message comprising an indication that an investigation has started related to the terminal; and
transmit the moduli-set associated with the terminal to the second network element.

18. A non-transitory computer readable medium having stored thereon a set of computer readable instructions that, when executed by at least one processor, cause an apparatus to at least:
receive, from a first network element, a first share of a private key associated with a terminal;
transmit a message, comprising an indication that an investigation has started related to the terminal, to a blockchain;
receive, from a third network element, a second share of the private key associated with the terminal;
receive, from the first network element, a moduli-set associated with the terminal, the moduli-set having been used to generate the first and second shares of the private key;
reconstruct the private key using the first and the second share of the private key and the moduli-set; and
decrypt a password associated with the terminal using the private key.

19. A non-transitory computer readable medium having stored thereon a set of computer readable instructions that, when executed by at least one processor, cause an apparatus to at least:
receive, from a first network element, a second share of a private key associated with a terminal;
receive via a blockchain, from a second network element, a message comprising an indication that an investigation has started related to the terminal; and
transmit, to the second network element, the second share of the private key associated with the terminal.

20. (canceled)
